(19) United States
(12) Patent Application Publication
(10) Pub. No.: US 2022/0097891 A1
(43) Pub. Date: Mar. 31, 2022

(54) MANUAL LABELING DEVICE

(71) Applicant: Powertech Technology Inc., Hukou Township (TW)

(72) Inventors: Yen Yu CHEN, Hukou Township (TW); Shin-Kung CHEN, Hukou Township (TW); Yuan-Jung LU, Hukou Township (TW); Hsing-Fu PENG, Hukou Township (TW)

(73) Assignee: Powertech Technology Inc., Hukou Township (TW)

(21) Appl. No.: 17/217,207

(22) Filed: Mar. 30, 2021

(30) Foreign Application Priority Data
Sep. 30, 2020 (TW) 109134293

(51) Int. Cl. B65C 9/26; B65C 9/06

(52) U.S. Cl. CPC B65C 9/262; B65C 9/06

(57) ABSTRACT

A manual labeling device is disclosed. The manual labeling device has a platform, a plurality of positioning elements and a pivoting device. The platform has a labeling area. The positioning elements are mounted on the platform and around the labeling area. The pivoting device is pivotally mounted on one side of the platform and has a pivot shaft and a pivot arm. The operator manually places one product in the labeling area of the platform and the product is fixed in the labeling area by the positioning elements. The operator only pivots the pivot arm and the pivot arm directly aligns with the labeling area. Therefore, it does not take times to align the tool and the labeling area before attaching the label and the label attaching task is simplified to increase the productivity and quality of labeling (units per hour; UPH).

### CROSS-REFERENCE TO RELATED APPLICATIONS

This application is based upon and claims priority under 35 U.S.C. 119 from Taiwan Patent Application No. 109134293 filed on Sep. 30, 2020, which is hereby specifically incorporated herein by this reference thereto.

### BACKGROUND OF THE INVENTION

### 1. Field of the Invention

The present invention is related to a labeling device, and more particularly to a manual labeling device.

### 2. Description of the Prior Arts

When products are ready to ship, labels are respectively labeled on the products. Since a labeling area on the product is preset and fixed, the label has to be accurately attached to the labeling area by hands. The operator may use a tool to help that the label align the labeling area, but it also takes time to position the tool.

After repeating this action to position the tool and align the label to the labeling area for a long time, the operator quickly fatigue. Therefore, the productivity of labeling (units per hour; UPH) is decreasing, and the labeling quality is decreasing, too.

To overcome the shortcomings, the present invention provides a manual labeling device to mitigate or to obviate the aforementioned problems.

### SUMMARY OF THE INVENTION

An objective of the present invention is to provide a manual labeling device.

To achieve the objective as mentioned above, the manual labeling device has:

a platform having a labeling area;

a plurality of positioning elements formed on the platform and around the labeling area; and

a pivoting device pivotally mounted on one side of the platform and having a pivot shaft and a pivot arm, wherein the pivot shaft is pivotally mounted through one side of the pivot arm, and the pivot arm pivots relative to the platform and aligns with the labeling area.

With the foregoing description, since the pivoting device is pivotally mounted the side of the platform, an operator can easily pivot the pivot arm to align the labeling area after a product is placed on the labeling area. After then, the operator directly attaches a label on the labeling area of the product defined by the pivot arm. Therefore, it does not take time to align the tool and the labeling area before attaching the label. The label attaching task is simplified to increase the productivity and quality of labeling (units per hour; UPH).

Other objectives, advantages and novel features of the invention will become more apparent from the following detailed description when taken in conjunction with the accompanying drawings.

### BRIEF DESCRIPTION OF′ THE DRAWINGS

FIG. 1A is a perspective view of a manual labeling device in accordance with the present invention;

FIG. 1B is an operation view of the manual labeling device in accordance with the present invention;

FIG. 2 is an exploded view of the manual labeling device in accordance with the present invention;

FIG. 3A is an operation view of the fine-tuning first axis of the manual labeling device in accordance with the present invention;

FIG. 3B is an operation view of the fine-tuning second axis of the manual labeling device in accordance with the present invention;

FIG. 4 is an exploded view of a pivoting device of the manual labeling device in accordance with the present invention;

FIG. 5 is a cross sectional view of a first positioning element of the manual labeling device in accordance with the present invention;

FIG. 6A is an operation view of a product mounted on the manual labeling device in accordance with the present invention; and

FIG. 6B is an operation view of a label attached on the manual labeling device in accordance with the present invention.

### DETAILED DESCRIPTION OF THE PREFERRED EMBODIMENTS

With multiple embodiments and drawings thereof, the features of the present invention are described in detail as follows.

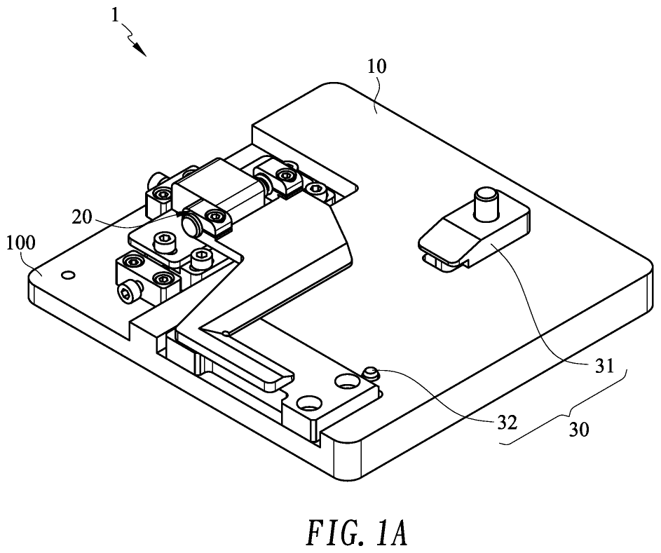

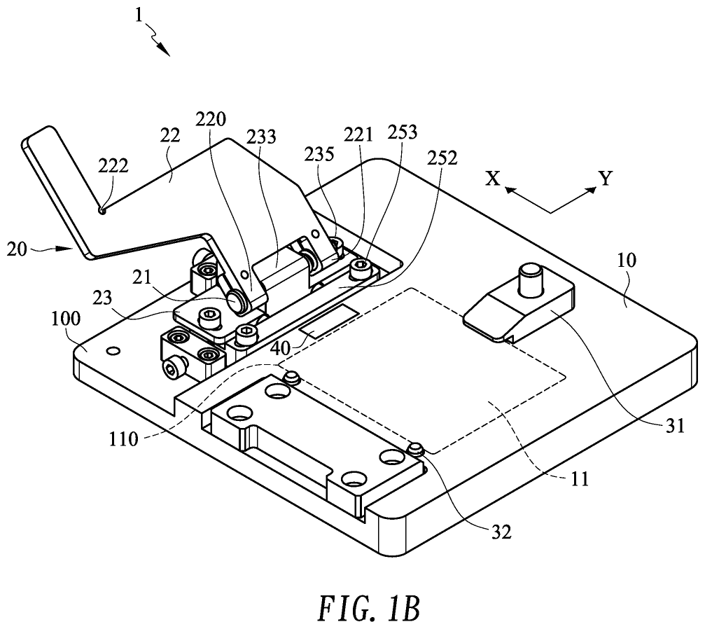

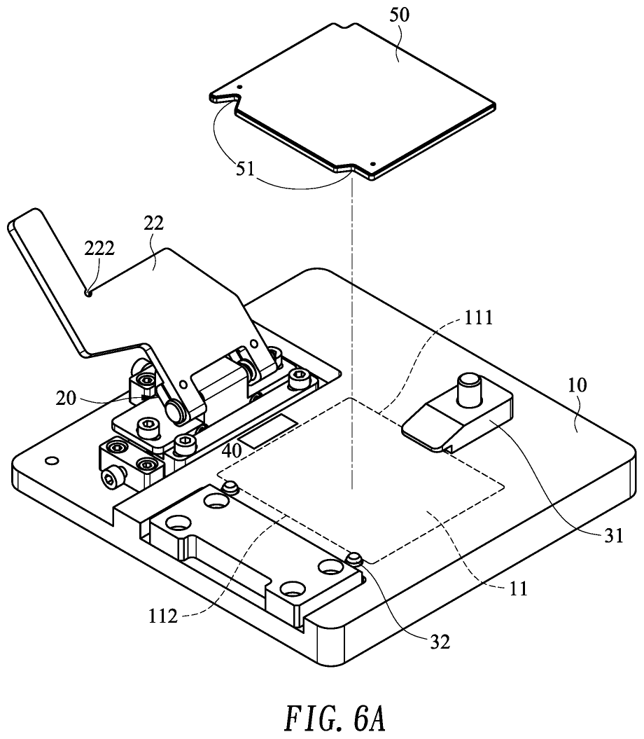

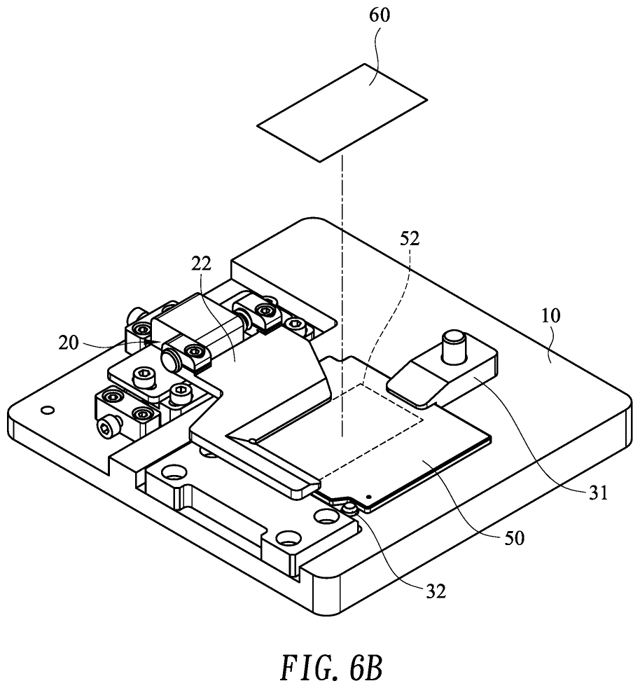

With reference to FIGS. 1A and 1B, a manual labeling device 1 has a platform 10, a plurality of positioning elements 30 and a pivoting device 20. The platform 10 has a labeling area 11, The positioning elements 30 mounted on the platform 10 and around the labeling area 11. The positioning elements 30 include a first positioning element 31 and a second positioning element 32. A size of the labeling area 11 matches a size of a product to be labeled. As shown in FIG. 6A, the product 50 may be a carrier or other electrical components.

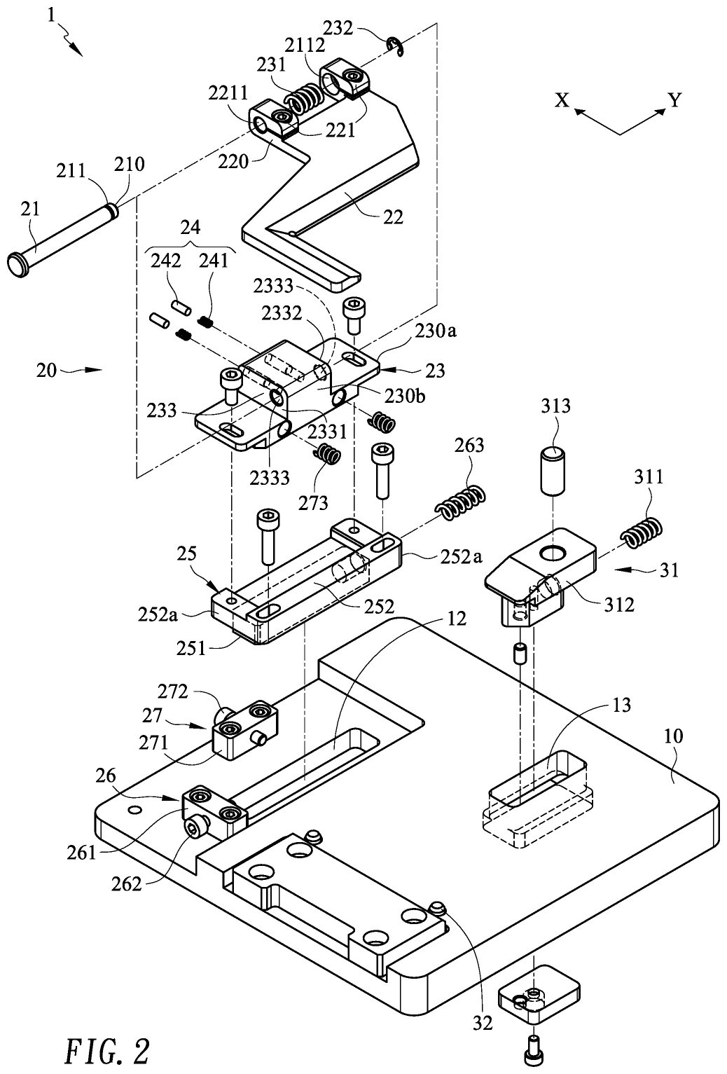

As shown in FIG. 1B, the pivoting device 20 is pivotally mounted on a side 100 of the platform 10 and has a pivot shaft 21 and pivot arm 22. In one embodiment, the pivoting device 20 is pivotally mounted on one side 100 of the platform 10 and corresponds to one corner 110 of the labeling area 11 close to the side 100 of the platform 10. In one embodiment, the pivot shaft 21 is mounted through a side 220 of the pivot arm 22 along a first axis Y, In one embodiment, the pivot arm 22 is formed of an L-shape and has a right-angle recess 222 corresponding to the corner 110 of the labeling area 11. When the pivot arm 22 is pivoted to the labeling area 11, the right-angle recess 222 may align with the corner 110 of the labeling area 11. The pivot shaft 21 and the pivot arm 22 are made of metal material, such as stainless steel or alloy and are not easily deformed after pivot repeatedly. In one embodiment, with reference to FIG. 2, two protruding blocks 221 are formed on the side 220 of the pivot arm 22 along the first axis Y. A first and second through holes 2211, 2112 are respectively formed through the protruding blocks 221 and align to each other.

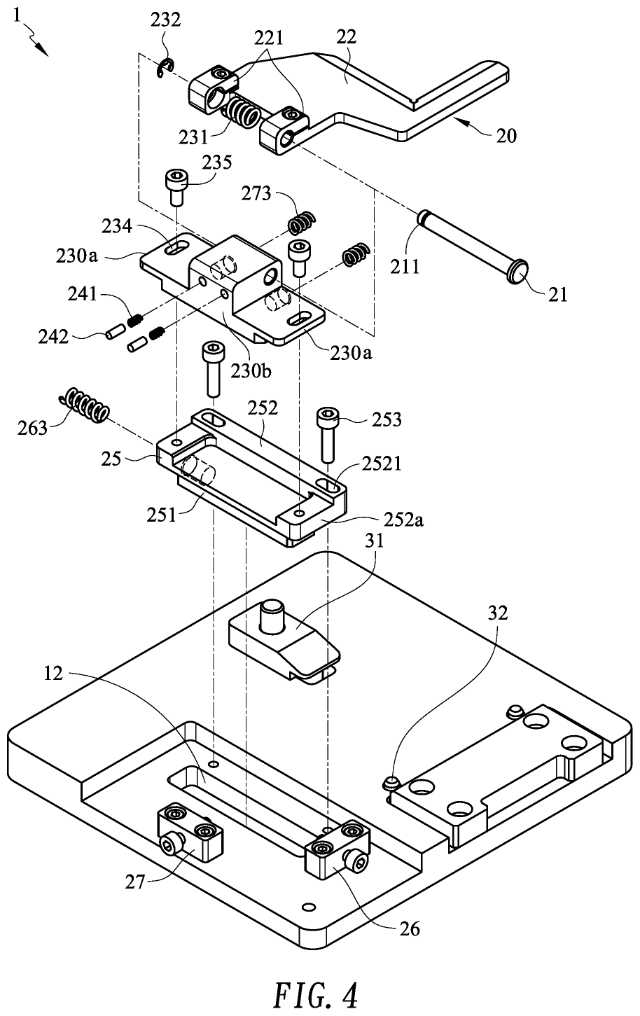

With reference to FIGS. 2 and 4, the pivoting device 20 has a first base 23. The first base 23 is mounted on the side of the platform 10 and has a pivot seat 223 and a first elastomer 231. The pivot seat 223 and the first elastomer 231 are placed between the two protruding blocks 221 of the side of the pivot arm 22. A third through hole 2333 is formed through the first and second sides 2331, 2332 of the pivot seats 233 and align the first and second through holes 2211, 2112 of the protruding blocks 221. In one embodiment, a free end 210 of the pivot shaft 21 is sequentially inserted through the first through hole 2211, the third through hole 2333, the first elastomer 231 and the second through hole 2112, and then protrudes from one of the protruding blocks 221 through which the second through hole 2112 is formed. A concave part 211 is formed on the free end 210 of the pivot shaft 21. A fixing ring 232 is mounted in the concave part 211 of the free end 210 of the pivot shaft 21, so the pivot shaft 21 does not fall off after pivot repeatedly. In one embodiment, the first elastomer 231 may be a spring or other elastic element that can be reset by force. As shown in FIG. 2, the pivot seat 233 and the first base 23 are formed integrally. The fixing ring 232 is an E-shaped buckle made of stainless steel. Two first long slots 234 are formed respectively through two opposite short sides 230a of the first base 23 along the second axis X. Two first screws 235 passes through the two first long slot 234.

With reference to FIGS. 2 and 4, the pivoting device 20 further has a gap-removing device 24 mounted in the first base 23 along a second axis X. The gap-removing device 24 has at least one second elastomer 241 and at least one pin 242. The second elastomer 241 is mounted through a long sidewall 230b of the first base 23 along the second axis X and one end of the second elastomer 241 presses against an outside of the pivot shaft 21 in the third through hole 2333, The pin 242 is mounted through the first base 23 along the second axis X and presses against the other end of the elastomer 241. The pin 242 can adjust a length of the elastomer 241 to change pressure on the pivot shaft 21. Therefore, a gap between the third through hole 2333 and the pivot shaft 21 is removed by adjusting the position of the pin 242 relative to the first base 23. In one embodiment, the second elastomer 241 may be a spring or other elastic element that can be reset by force. The pin 242 may be screw or the like.

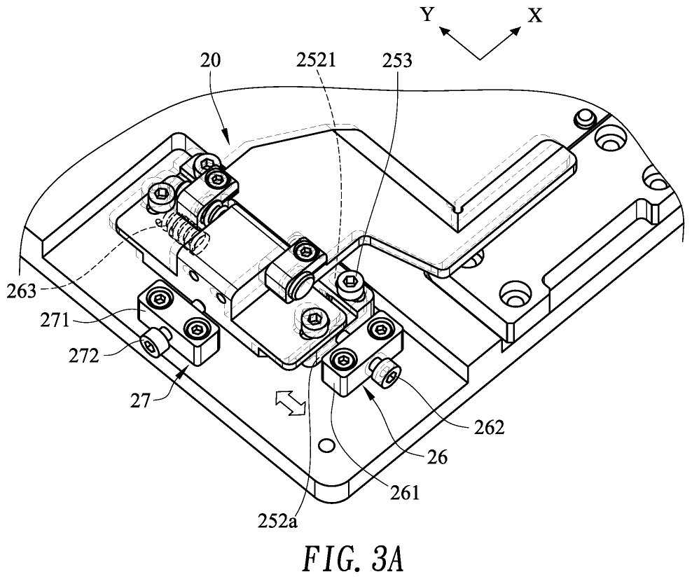

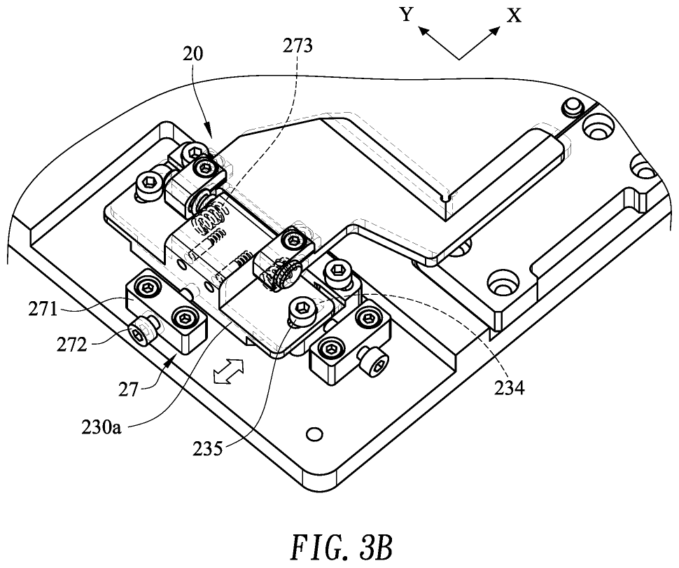

With reference to FIGS. 2 and 4, a first sliding slot 12 is formed on one side of the platform 10 corresponding to the pivot device 20 along the first axis Y. The pivot device 20 further has a second base 25, an upper bump 252 extending from a top of the second base 25 and a lower bump 251 extending from a bottom of the second base 25. The first base 23 is moveably mounted on a top of the second base 25 by the two first screws 235. A first space is defined between another long sidewall 230b of the first base 23 and the upper bump 252. Since a length of each first long slot 234 is larger than a diameter of the first screw 235, the first base 23 may slide relative to the second base 25 along the second axis X. Two second long slots 2521 are formed through the upper bump 252 along the first axis Y. Two second screws 253 are mounted on the platform 10 by respectively passing through the two second long slot 2521, A length of each second long slot 2521 is larger than a diameter of the second screw 253. The second base 25 is moveably mounted on the side of the platform 10 by the two second screws 253. The lower bump 251 is moveably mounted in the first sliding slot 12 of the platform 10 and a second space is defined between the lower bump 251 and an inner sidewall 121 of the first sliding slot 12. Therefore, the second base 25 may horizontally slide along the first axis Y. In one embodiment, the pivot device 20 further has a first axis fine-tuning device 26 and a second-axis fine-tuning device 27. The first axis fine-tuning device 26 is mounted on the platform 10 along the first axis Y and corresponds to a short side of the first sliding slot 12. The first axis fine-tuning device 26 has a first seat 261, a third screw 262 and a first spring 263. The third screw 262 is mounted through the first seat 261 and presses against a short sidewall 252a of the second base 25. The first spring 263 mounted in the second space to press against the short sidewall 252a of the lower bump 251 and the inner sidewall 121 of the first sliding slot 12. The position of the second base 25 relative to the platform 10 is adjusted by the third screw 262 and a length of the first spring 263 is relatively changed, too. Therefore, the position of the pivot arm 22 relative to labeling area 11 on the first axis Y is fine-tuned, as shown in FIG. 3A.

The second-axis fine-tuning device 27 is mounted on the platform 10 along the second axis X and corresponding to a long side of the first sliding slot 12. The second axis fine-tuning device 27 has a second seat 271, a fourth screw 272 and a second spring 273. The fourth screw 272 is mounted through the second seat 271 and pressing against the long sidewall 230b of the first base 23. The second spring 273 is mounted in the first space to press against the long sidewall of the first base 23 and the upper bump 252 of the second base 25, Since the first base 23 is mounted on the second base 25, the position of the first base 23 relative to the second base 25 is adjusted by the fourth screw 272 and a length of the second spring 273 is also relatively changed. Therefore, the position of the pivot arm 22 relative to labeling area 11 on the second axis X is fine-tuned, as shown in FIG. 3B.

The position of the pivot arm 22 relative to labeling area 11 on the first axis Y and the second axis X is fine-timed by the first and second-axis fine-tuning devices 26, 27 to align the right angle recess 222 with the corresponding corner of the labeling area 11. After then, the operator can manually pivot the pivot arm 22 of the pivoting device 20 clockwise to align a labeling position of the labeling area 11.

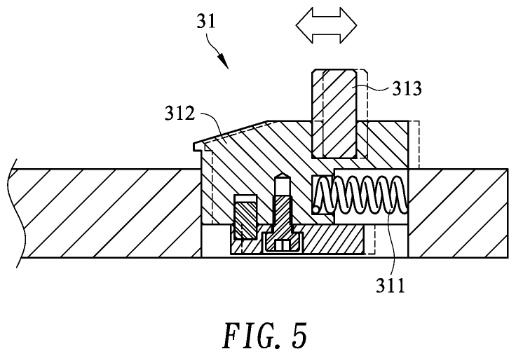

With reference to FIGS. 5 and 6A, in one embodiment, one first positioning element 31 and two second positioning element 32 are mounted on the platform 10 to fix the product, such as a carrier or the like, on the platform 10. With reference to FIG. 4, the first positioning element is movably mounted on the platform 10 and corresponds to a first side 111 of the labeling area 11. The two second positioning elements 32 are securely mounted on the platform 10 and corresponds to a second side 112 of the labeling area 11. The first and second sides 111, 112 are opposite. The first positioning element 31 and the two second positioning elements 32 are formed to a three-point fixed area. The two second positioning element 32 may be a positioning pin. In another embodiment, single or more than two positioning pins may be formed around the labeling area 11 according to different products. A second sliding slot 13 is further formed on the platform 10 and corresponds to the first positioning element 31. The first positioning element 31 has a sliding block 312, a third elastomer 311 and a protruding part 313. The sliding block 312 is slidably mounted in second sliding slot 13 and a gap is defined between the sliding block 312 and the second sliding slot 13. The third elastomer 311 is mounted in the second sliding slot 13. The operator holds the protruding part 313 formed on the sliding block 312 to move the sliding block 312 along the first axis Y. The third elastomer 311 may be a spring or other elastic element that can be reset by force.

With reference to FIGS. 5, 6A and 6B, two positioning recesses 51 are formed on one side of the product 50. The operator moves the sliding block 312 away the first side 111 of the labeling area 11 to completely expose the labeling area 11. At the time, the third elastomer 311 is compressed. The two positioning recesses 51 of the product 50 respectively align with the two second positioning elements 32 and then place the product 50 in the labeling area 11. After then, the operator releases the positioning part 313 of the first positioning element 31 and the sliding block 312 is moved back to an original position by the third elastomer 311 to press against the product 50. The product 50 is fixed in the labeling area 11 by the first and second positioning elements 31, 32. The adhesive FC attach (PSA) task can be operated. With further reference to FIG. 1B, a buffer pad 40 is mounted between the pivoting device 20 and the platform 10 close to the labeling area 11. The buffer pad 40 absorbs pivoting force and the pivot arm 22 collides a top surface of the product 50 is avoided. After a label L is attached on the top surface 52 of the product 50, the operator pivots the pivot arm 22 counterclockwise to complete the PSA task.

Based on foregoing description, since the pivoting device is pivotally mounted the side of the platform, an operator can easily pivot the pivot arm to align the labeling area after a product is placed on the labeling area. After then, the operator directly attaches a label on the labeling area of the product defined by the pivot arm. Therefore, it does not take times to align the tool and the labeling area before attaching the label and the label attaching task is simplified to increase the productivity and quality of labeling (units per hour; UPH).

Even though numerous characteristics and advantages of the present invention have been set forth in the foregoing description, together with the details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A manual labeling device, comprising:
a platform having a labeling area;
a plurality of positioning elements formed on the platform and around the labeling area; and
a pivoting device pivotally mounted on one side of the platform and having a pivot shaft and a pivot arm, wherein the pivot shaft is pivotally mounted through one side of the pivot arm, and the pivot arm pivots relative to the platform and aligns with the labeling area.

2. The manual labeling device as claimed in claim 1, wherein the pivot arm comprising a right-angel recess to align with one corner of the labeling area.

3. The manual labeling device as claimed in claim 1, wherein the pivoting device further comprises:
two protruding blocks formed on the side of the pivot arm;
a first through hole formed through one of the protruding blocks; and
a second through hole formed through the other protruding block;
a first base mounted on the side of the platform and having:
a pivot shaft mounted between the two protruding blocks;
a third through hole formed through the pivot shaft and aligning with the first and second through holes; and
a first elastomer mounted between a pivot seat and one of the protruding blocks, wherein a free end of the pivot shaft mounted through the two protruding blocks, the pivot seat and the first elastomer through the first through hole, the third through hole and the second through hole, and then protruding from one of the protruding blocks; and
a fixing ring mounted on the fee end of the pivot shaft.

4. The manual labeling device as claimed in claim 3, wherein the pivoting device further comprises a gap-removing device mounted in the platform and comprising:
at least one second elastomer mounted through a first long sidewall of the first base along the second axis, and one end of the at least one second elastomer pressing against an outside of the pivot shaft; and
at least one pin mounted through the first base along the second axis, and pressing against the other end of the at least one second elastomer.

5. The manual labeling device as claimed in claim 3, wherein
a first sliding slot is formed on the side of the platform and corresponds to the pivot device along the first axis;
two first long slots are respectively formed through the first base along the second axis; and
the pivoting device further comprises:
a second base having:
a top on which the first base is screwed by two first screws, wherein a diameter of each first screw is smaller than a length of the first long slot;
an upper bump integrally extending from the top of the second base and correspond to the first base, wherein a first space is defined between a second long sidewall of the first base and the upper bump; and
a lower bump mounted in the first sliding slot, wherein a second space is defined between the lower bump and an inner sidewall of the first sliding slot; and
a first axis fine-tuning device having:
a first seat mounted on the platform along the first axis and corresponding to one short side of the first sliding slot;
a first spring mounted in the second space; and
a third screw mounted through the first seat and pressing against a short sidewall of the second base.

6. The manual labeling device as claimed in claim 4, wherein
a first sliding slot is formed on the side of the platform and corresponds to the pivot device along the first axis;
two first long slots are respectively formed through the first base along the second axis; and
the pivoting device further comprises:
a second base having:
a top on which the first base is screwed by two first screws, wherein a diameter of each first screw is smaller than a length of the first long slot;
an upper bump integrally extending from the top of the second base and correspond to the first base, wherein a first space is defined between a second long sidewall of the first base and the upper bump; and
a lower bump mounted in the first sliding slot, wherein a second space is defined between the lower bump and an inner sidewall of the first sliding slot; and
a first axis fine-tuning device having:
a first seat mounted on the platform along the first axis and corresponding to one short side of the first sliding slot;
a first spring mounted in the second space; and
a third screw mounted through the first seat and pressing against a short sidewall of the second base.

7. The manual labeling device as claimed in claim 5, wherein the pivoting device further comprises a second axis fine-tuning device having:
a second seat mounted on the platform along the first axis and corresponding to one long side of the first sliding slot;
a second spring mounted in the second gap; and
a fourth screw mounted through the second seat and pressing against the first long sidewall of the first base.

8. The manual labeling device as claimed in claim 6, wherein the pivoting device further comprises a second axis fine-tuning device having:
a second seat mounted on the platform along the first axis and corresponding to one long side of the first sliding slot;
a second spring mounted in the second gap; and
a fourth screw mounted through the second seat and pressing against the first long sidewall of the first base.

9. The manual labeling device as claimed in claim 1, wherein the positioning elements comprise:
a first positioning element movably mounted on the platform and corresponding to a first side of the labeling area; and
at least one second positioning element securely mounted on the platform and corresponding to a second side of the labeling area, wherein the second side is opposite to the first side.

10. The manual labeling device as claimed in claim 9, wherein
a second sliding slot is formed on the platform and corresponding to the first positioning element, along the first axis; and
the first positioning element has:
a sliding block having a bottom, wherein the bottom slidably mounted in the second sliding slot and a third gap is defined between the bottom and an inner sidewall of the second sliding slot; and
a third spring mounted between the bottom and the inner sidewall of the second sliding slot, wherein the sliding block is moved back and forth in the second sliding slot along the first axis.

11. The manual labeling device as claimed in claim 9, wherein the first positioning element further comprises a positioning pin formed on a top of the sliding block.

12. The manual labeling device as claimed in claim 1, further comprising a buffer pad formed on the platform and corresponding to the pivoting device.

13. The manual labeling device as claimed in claim 4, further comprising a buffer pad formed on the platform and corresponding to the pivoting device.

14. The manual labeling device as claimed in claim 6, further comprising a buffer pad formed on the platform and corresponding to the pivoting device.

15. The manual labeling device as claimed in claim 8, further comprising a buffer pad formed on the platform and corresponding to the pivoting device.

16. The manual labeling device as claimed in claim 3, wherein a concave part is formed on the free end of the pivot shaft and the fixing ring is mounted in the concave part.

17. The manual labeling device as claimed in claim 4, wherein a concave part is formed on the free end of the pivot shaft and the fixing ring is mounted in the concave part.

18. The manual labeling device as claimed in claim 5, wherein a concave part is formed on the free end of the pivot shaft and the fixing ring is mounted in the concave part.

19. The manual labeling device as claimed in claim 6, wherein a concave part is formed on the free end of the pivot shaft and the fixing ring is mounted in the concave part.

20. The manual labeling device as claimed in claim 8, wherein a concave part is formed on the free end of the pivot shaft and the fixing ring is mounted in the concave part.
